(19) United States
(12) Patent Application Publication
(10) Pub. No.: US 2026/0021536 A1
(43) Pub. Date: Jan. 22, 2026

(54) ROTARY TOOL GUIDE

(71) Applicant: Aaron Browning Frankl, Los Angeles, CA (US)

(72) Inventor: Aaron Browning Frankl, Los Angeles, CA (US)

(21) Appl. No.: 19/275,951

(22) Filed: Jul. 21, 2025

Related U.S. Application Data
(60) Provisional application No. 63/673,169, filed on Jul. 19, 2024.

(51) Int. Cl. B23B 45/00; B23B 35/00

(52) U.S. Cl. CPC B23B 45/003; B23B 35/00

(57) ABSTRACT

A rotary tool guide, such as a drill guide, includes a rotation transmission member and a tool guiding member. The rotation transmission member includes a rotary shaft extending to an end equipped with an object engaging mechanism adapted to engage an object, such as a bit, that is to be rotated. The tool guiding member includes a tool guide shaft and a surface contacting member. The tool guide shaft has a lumen adapted to receive the rotary shaft therein. The surface contacting member comprises a contacting surface adapted to contact a surface of a workpiece. The contacting surface of the surface contacting member defines an orientation angle relative to a longitudinal axis of the tool guide shaft lumen so that when the rotary shaft is advanced, the rotary shaft is maintained at the orientation angle.

### PRIORITY

The present application claims the benefit of domestic priority based on United States Provisional Patent Application 63/673,169 filed on Jul. 19, 2024, the entirety of which is incorporated herein by reference.

### BACKGROUND

Power drills and other rotary tools have become ubiquitously used in households, workshops, and job sites. The operation of a drill is relatively simple. Attach a bit, such as a drill bit or driver bit, to a clamping chuck on the drill and then press a trigger. The drill causes the bit to rotate so that a hole can be bored, a fastener can be advanced, or other object can be rotated.

However, while the operation of a drill is simple, precise control of the drilling process, especially when using a handheld drill, can be more daunting. Novice operators can have difficulty maintaining a proper orientation of the drill when a hole is to be drilled or a fastener is to be advanced at a desired angle, and experienced operators must expend extra time and focus when precision drilling is required. A slight improper movement or the momentary loss of concentration can cause a drill bit or fastener to be inserted at angle other than desired. The task is challenging enough when it is desired for the drilled hole or fastener to be 90 degrees from a surface of an object, but it becomes even more challenging when the desired angle is other than 90 degrees, such as 45 degrees or 30 degrees. In this case, the operator using a conventional drill must not only maintain a constant angle of the drill during the drilling process but must do so by estimating or eyeballing the angle during the drilling process and without any reference. Accurate and reproducible drilling with conventional drills, especially when numerous drilling processes are to be accomplished, can therefore require much time and effort. Moreover, when there are mistakes or less than perfect execution, the process must be repeated, adding even more time to a project. In addition to the angular orientation of the drill, the depth of drilling can also be a challenge to accurately and repeatably control with a conventional handheld drill.

Attempts have been made to make the drilling process more precise. For example, complex rigs and drill presses can be set up that accurately control the orientation of a drill relative to a work surface. However, these systems are complicated and cumbersome, and many drilling situations are not suited for their use. Also, one of the benefits of a handheld drill is its portability and ease of use in a variety of spaces and jobs, and this is negated by a complex rig or drill press. The problem has also been attempted to be overcome by providing a drill guide on a bit, but this is both inconvenient and limiting in its use. In addition to not being sufficiently robust, the drill bit guide does not allow for the easy and effective exchange of bits, adding steps and frustration to a project.

Therefore, there is a need for an improved guide for a rotary tool, such as a drill and particularly a handheld drill. There is a further need for a rotary tool guide that is connected or connectable to a rotary tool and can be used with various bits. There is a further need for a rotary tool guide that is connected or connectable to a rotary tool and that helps to maintain a desired angle of a drilling process and/or limits the depth of a drilling process.

### SUMMARY

The present invention satisfies one or more of these needs. In one aspect of the invention, an improved guide for a rotary tool, such as a drill, is provided.

In another aspect of the invention, an improved rotary tool, such as a drill, is provided.

In another aspect of the invention, a rotary tool guide in the form of an adapter or extender that is releasably connectable to a rotary tool, such as a drill, is provided.

In another aspect of the invention, a rotary tool guide is connected to or connectable to a rotary tool at a first end and to a bit or other object to be rotated at another end.

In another aspect of the invention, a rotary tool guide comprises an adapter or extender releasably connectable to a rotary tool at a first end and to a bit or other object to be rotated at another end.

In another aspect of the invention, a rotary tool guide is connected to or connectable to a rotary tool at a first end and to a bit or other object to be rotated at another end, wherein the rotary tool guide comprises an insertion angle guide adapted to maintain an angle of drilling at a desired angle.

In another aspect of the invention, a rotary tool guide is connected to or connectable to a rotary tool at a first end and to a bit or other object to be rotated at another end, wherein the rotary tool guide comprises an insertion angle guide adapted to maintain an angle of drilling at a desired angle, wherein the desired angle is 90 degrees from a surface of an objected being drilled into.

In another aspect of the invention, a rotary tool guide is connected to or connectable to a rotary tool at a first end and to a bit or other object to be rotated at another end, wherein the rotary tool guide comprises an insertion angle guide adapted to maintain an angle of drilling at a desired angle, wherein the desired angle is 45 degrees from a surface of an objected being drilled into.

In another aspect of the invention, a rotary tool guide is connected to or connectable to a rotary tool at a first end and to a bit or other object to be rotated at another end, wherein the rotary tool guide comprises an insertion angle guide adapted to maintain an angle of drilling at a desired angle, wherein the desired angle is adjustable.

In another aspect of the invention, a rotary tool guide is connected to or connectable to a rotary tool at a first end and to a bit or other object to be rotated at another end, wherein the rotary tool guide comprises an insertion depth limiting mechanism.

In another aspect of the invention, a rotary tool guide is connected to or connectable to a rotary tool at a first end and to a bit or other object to be rotated at another end, wherein the rotary tool guide comprises an insertion angle guide adapted to maintain an angle of drilling at a desired angle, and wherein the rotary tool guide comprises an insertion depth limiting mechanism.

In another aspect of the invention, a method of using a rotary tool comprises providing a rotary tool guide as described herein and using the rotary tool guide as described herein.

In another aspect of the invention, a rotary tool guide comprises a rotation transmission member comprising a rotary shaft extending from a mount at a rotary shaft first end to a rotary shaft second end, wherein the mount is adapted to connect the rotation transmission member to a rotary tool, and wherein the rotary shaft second end is equipped with an object engaging mechanism adapted to engage an object that is to be rotated; and a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface adapted to contact a surface of a workpiece, wherein the contacting surface of the surface contacting member defines an orientation angle relative to a longitudinal axis of the tool guide shaft lumen so that when the rotary shaft is moved within the tool guide shaft lumen from a retracted position to an advanced position, the rotary shaft is maintained at the orientation angle relative to the surface of the workpiece that is contacted by the surface contacting member.

In another aspect of the invention, a drilling system comprises a rotary tool; a rotary tool guide, the rotary tool guide comprising: a rotation transmission member comprising a rotary shaft extending from a mount at a rotary shaft first end to a rotary shaft second end, wherein the mount connects the rotation transmission member to the rotary tool, and wherein the rotary shaft second end is equipped with a bit engaging mechanism adapted to engage a bit that is to be rotated; and a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface adapted to contact a surface of a workpiece; and one or more bits adapted to be engaged by the bit engagement mechanism in a manner where rotation of the rotary shaft causes rotation of the bit, wherein the contacting surface of the surface contacting member defines an orientation angle relative to a longitudinal axis of the tool guide shaft lumen so that when the rotary shaft is moved within the tool guide shaft lumen from a retracted position to an advanced position, the rotary shaft and a bit engaged by the bit engaging mechanism are maintained at the orientation angle relative to the surface of the workpiece that is contacted by the surface contacting member.

In another aspect of the invention, a method of using a rotary tool comprises providing a rotary tool connected to a rotary tool guide, wherein the rotary tool guide comprises: a rotation transmission member comprising a rotary shaft extending from a rotary shaft first end to a rotary shaft second end, wherein the rotary shaft second end is equipped with an object engaging mechanism; and a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface; engaging an object to be rotated with the object engaging mechanism; contacting a surface of a workpiece with the contacting surface of the surface contacting member; rotating the rotary tool and thereby rotating the rotary shaft and the object to be rotated; and advancing the rotary shaft within the tool guide shaft lumen and thereby advancing the object to be rotated, wherein the contacting surface of the surface contacting member defines an orientation angle relative to a longitudinal axis of the tool guide shaft lumen so that when the rotary shaft and the object to be rotated are advanced, the rotary shaft and the object to be rotated are maintained at the orientation angle relative to the surface of the workpiece that is contacted by the surface contacting member.

### BRIEF DESCRIPTION OF THE DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1A is a schematic perspective view of a version of a rotary tool guide of the invention in a retracted position;

FIG. 1B is a schematic perspective view of the rotary tool guide of FIG. 1A in an advanced position;

FIG. 2A is a schematic sectional side view of the rotary tool guide of FIGS. 1A and 1B in a retracted position;

FIG. 2B is a schematic sectional side view of the rotary tool guide of FIGS. 1A and 1B in an advanced position;

FIG. 3A is a schematic top view of the rotary tool guide of FIGS. 1A and 1B;

FIG. 3B is a schematic bottom view of the rotary tool guide of FIGS. 1A and 1B;

FIG. 4 is a schematic perspective view of the rotary tool guide of FIGS. 1A and 1B in use in a drilling system;

FIG. 5A is a schematic perspective view of the rotary tool guide of FIGS. 1A and 1B in use in a drilling system with the rotary tool guide in a retracted position;

FIG. 5B is a schematic perspective view of the rotary tool guide of FIGS. 1A and 1B in use in a drilling system with the rotary tool guide in an advanced position;

FIG. 6A is a schematic perspective view of the rotary tool guide of FIGS. 1A and 1B in use in a drilling system in the process of drilling a hole with the rotary tool guide in a retracted position;

FIG. 6B is a schematic perspective view of the rotary tool guide of FIGS. 1A and 1B in use in a drilling system in the process of drilling a hole with the rotary tool guide in an advanced position;

FIG. 7A is a schematic perspective view of another version of a rotary tool guide of the invention;

FIG. 7B is a schematic side view of the rotary tool guide of FIG. 7A;

FIG. 8A is a schematic perspective view of another version of a rotary tool guide of the invention;

FIG. 8B is a schematic perspective view from below of the rotary tool guide of FIG. 8A;

FIG. 9A is a schematic perspective view of another version of a rotary tool guide of the invention in a first orientation;

FIG. 9B is a schematic side view of the rotary tool guide of FIG. 9A in the first orientation;

FIG. 10A is a schematic perspective view of the rotary tool guide of FIG. 9A in a second orientation;

FIG. 10B is a schematic side view of the rotary tool guide of FIG. 9A in the second orientation;

FIG. 11A is a schematic side view of another version of a rotary tool guide of the invention;

FIG. 11B is a schematic sectional side view of the rotary tool guide of FIG. 11A;

FIG. 12A is a schematic perspective view of another version of a rotary tool guide of the invention in a retracted position;

FIG. 12B is a schematic perspective view of the rotary tool guide of FIG. 12A in an advanced position;

FIG. 13A is a schematic perspective view of another version of a rotary tool guide of the invention in a retracted position;

FIG. 13B is a schematic perspective view of the rotary tool guide of FIG. 13A in an advanced position;

FIG. 14A is a schematic perspective view of another version of a rotary tool guide of the invention in a retracted position;

FIG. 14B is a schematic perspective view of the rotary tool guide of FIG. 14A in an advanced position;

FIG. 15A is a schematic front view of a portion of a surface contacting member of a version of a rotary tool guide of the invention;

FIG. 15B is a schematic side view of the rotary tool guide of FIG. 15A;

FIG. 15C is a schematic side view of another version of the rotary tool guide of FIG. 15A;

FIG. 16A is a schematic perspective view of the rotary tool guide of FIGS. 1A and 1B in use in a drilling system in which it is permanently connected to a drill with the rotary tool guide in a retracted position; and

FIG. 16B is a schematic perspective view of the rotary tool guide of FIGS. 1A and 1B in use in a drilling system in which it is permanently connected to a drill with the rotary tool guide in an advanced position.

### DESCRIPTION

The present invention relates to a tool and/or an accessory for a tool. In particular, the invention relates to a guide for a rotary tool. Although the invention is illustrated and described in the context of being useful for maintaining an orientation of a rotary tool, such as a drill, the present invention can be used in other ways, as would be readily apparent to those of ordinary skill in the art. Accordingly, the present invention should not be limited just to the examples and embodiments described herein.

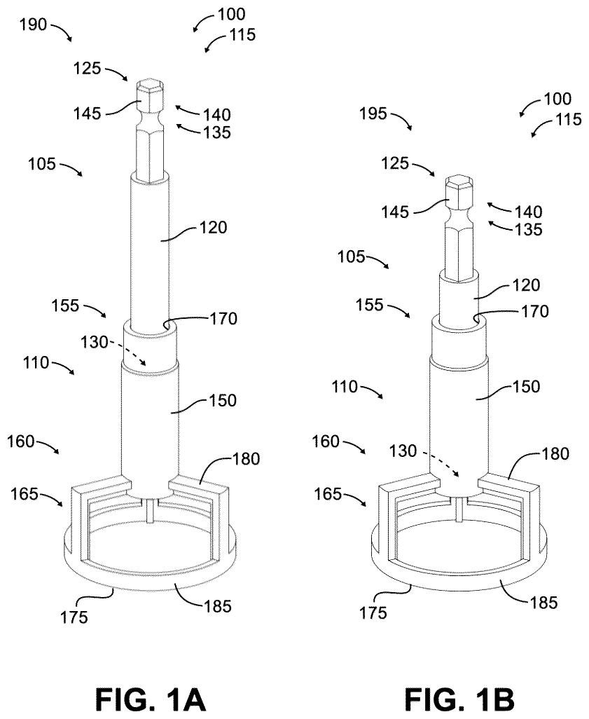

FIGS. 1A and 1B show a rotary tool guide 100 according to one version of the present invention. The rotary tool guide 100 comprises a rotation transmission member 105 and a tool guiding member 110. The tool guiding member 110 is moveable relative to the rotation transmission member 105, such as by being longitudinally slidable relative thereto and/or rotatable along a longitudinal axis relative thereto. The rotary tool guide 100 can be in the form of an accessory for a rotary tool, such as an adapter or extender, or can be an integral part of the rotary tool, as will be described. The rotary tool can be any tool that generates a rotational force and transfers the rotational force to another object. For example, the rotary tool can be a drill, such as a handheld drill, an electronic driver, such as an electronic screwdriver, a boring tool, an auger, or the like and combinations thereof. In one particular application, the rotary tool is a drilling device that provides a rotational force to a bit that is attached thereto and that can be used as either a drill or a driver. Often the bit will be a helically cut drill bit that is designed to cut a hole in an object when it is rotated by the rotary tool. The bit can also be a driver bit having an end configured to engage the head of a fastener or the like can be attached to the rotary drilling device to allow the drilling device to be used as a driver. A particular application for the rotary tool guide 100 of the invention is with a rotary tool that is adapted to cause a bit or other object to rotate and thereby cause the bit or other object to translate longitudinally, such as by boring a hole with a drill bit, advancing a fastener by rotation of a driver bit, and/or the like. The rotary tool guide 100 is designed and configured to guide the longitudinal translation in a desirable manner, such as by helping to maintain a desired angle of longitudinal translation and/or depth of longitudinal translation.

In the version of FIGS. 1A and 1B, the rotary tool guide 100 comprises an insertion angle guide 115 designed to help maintain a desired insertion angle for an object, such as a drill bit, a fastener being driven by a driver bit, and/or other cutters, such as an endmill. The rotation transmission member 105 connects the rotary tool to an object to be rotated and the tool guiding member 110 serves as an insertion angle guide 115 that helps to maintain the angle of the rotary tool, the object being rotated by the rotary tool, and/or the object being rotated by a bit connected to the rotary tool at a desired angle. For example, the insertion angle guide 115 can help to maintain the angle of the rotary tool, the object being rotated by the rotary tool, and/or the object being rotated by a bit connected to the rotary tool at a desired angle relative to a workpiece or surface that is being drilled into.

As can be seen in FIGS. 1A and 1B, the rotation transmission member 105 comprises a rotary shaft 120. In the version shown, the rotary shaft 120 has an outer surface that is at least partially cylindrical or at least a portion of which is circular in transverse cross section but other shapes that allow for the rotation of the rotary shaft 120 are possible. The rotary shaft 120 extends from a rotary shaft first end 125 to a rotary shaft second end 130 longitudinally spaced from the rotary shaft first end 125. The rotation transmission member 105 comprises a mount 135 rigidly connected or rotationally connected to or near the rotary shaft first end 125. The mount 135 is adapted to mount the rotary shaft 120 to a rotary tool in a manner that allows the rotary tool to rotate the rotary shaft 120. In the version of FIGS. 1A and 1B, the mount 135 comprises a releasable connector 140 that allows the rotary shaft 120 to be releasably connected to the rotary tool. In the particular version of FIGS. 1A and 1B, the releasable connector 140 comprises a hex shank 145 that is rigidly fixed to the rotary shaft 120 and that is receivable within a chuck, collet, quick change socket, hex cavity, or other interface with the rotary tool. The hex shank 145 has a hexagonal shaped cross section or other non-circular shape that can be engage the rotary tool, such as by being clamped onto by the rotary tool, so that rotation of the rotary tool causes rotation of the rotary shaft 120. Alternatively, the shank can be circular in cross section provided the rotary tool is able to clamp onto the shank with sufficient grip to be able to cause the rotary shaft to rotate. Rotation of the rotary shaft first end 125 is translated to the rotary shaft second end 130. The rotary shaft second end 130 is adapted to engage or is connected to a member that is adapted to engage an object that is to be rotated, such as a bit or other object, as will be described.

The tool guiding member 110 includes a tool guide shaft 150 that extends from a rotary shaft receiving end 155 to a surface contacting end 160 that includes or supports a surface contacting member 165. The rotary shaft receiving end 155 comprises a tool guide shaft lumen 170 along and through its interior. The tool guide shaft lumen 170 is sized and shaped to receive the outer surface of the rotary shaft 120 of the rotation transmission member 105 in a manner where the rotary shaft 120 is longitudinally slidable relative to the tool guide shaft 150 and within the tool guide shaft lumen 170. The rotary shaft 120 can also be rotatable relative to the tool guide shaft 150 within the tool guide shaft lumen 170. Accordingly, in one version, the rotary shaft 120 and the tool guide lumen 170 are designed to have a slip fit type of arrangement. The surface contacting member 165 comprises a contacting surface 175 adapted to contact a work surface. One or more forwardly projecting legs 180 extend from the tool guide shaft 150 and connect the contacting surface 175 to the tool guide shaft 150 at a fixed or fixable position and/or orientation. In the particular version of FIGS. 1A and 1B, the contacting surface 175 is on a forward end of a platform 185 that encircles or at least partially encircles a longitudinal axis of the tool guide shaft lumen 170. By lumen it is meant any passageway, whether completely enclosed or partially enclosed, that provides a path for controlling or containing the movement of the rotary shaft 120 therein. The tool guide shaft lumen 170 can be, for example, completely cylindrical or partially cylindrical, such as by being C-shaped or the like, or any other suitable shape or cross-sectional shape.

The contacting surface 175 is designed to define an orientation angle of the rotary tool guide 100. The orientation angle defines the angle of the contacting surface 175 relative to a longitudinal axis of the tool guide shaft lumen 170. For example, in the version of FIGS. 1A and 1B, the contacting surface 175 defines an orientation angle of 90 degrees relative to the longitudinal axis of the tool guide shaft lumen 170. In one version, the platform 185 is designed to provide a planar or at least partially planar contacting surface 175. The planar contacting surface can be provided, as in the version of FIGS. 1A and 1B by a continuous contacting surface 175 that lies in a plane defining the orientation angle. Alternatively, the contacting surface 175 can define a plane by discontinuous contacting surfaces 175 that are arranged in the plane defining the orientation angle. In another version, the contacting surface 175 can be in a shape other than planar, such as when it is intended to contact and/or correspond to a non-planar surface on a workpiece or object, as will be discussed.

FIGS. 1A and 1B illustrate the relative movement of the rotation transmission member 105 and the tool guide member 110 of the rotary tool guide 100. As discussed above, the rotation transmission member 105 is moveable relative to the tool guiding member 110 by the rotary shaft 120 of the rotation transmission member 105 being slidably translatable within the tool guide shaft lumen 170. FIG. 1A shows the rotary tool guide 100 in a retracted position 190 where the rotation transmission member 105 is retracted relative to the tool guiding member 110, and FIG. 1B shows the rotary tool guide in an advanced position 195 where the rotation transmission member 105 is extended forwardly within the tool guiding member 110 to a position forward of the retracted position 190. The rotary tool guide 100 is designed to control and/or guide the movement of the rotation transmission member 105, the rotary tool, and/or the object being rotated by the rotation transmission member 105. One manner in which the angular orientation is guided or maintained is by the relationship and fit of the rotary shaft 120 within the tool guide shaft 150. The tool guide shaft 150 and tool guide shaft lumen 170 can be any suitable length that helps to maintain the angular orientation and prevents or reduces wobble.

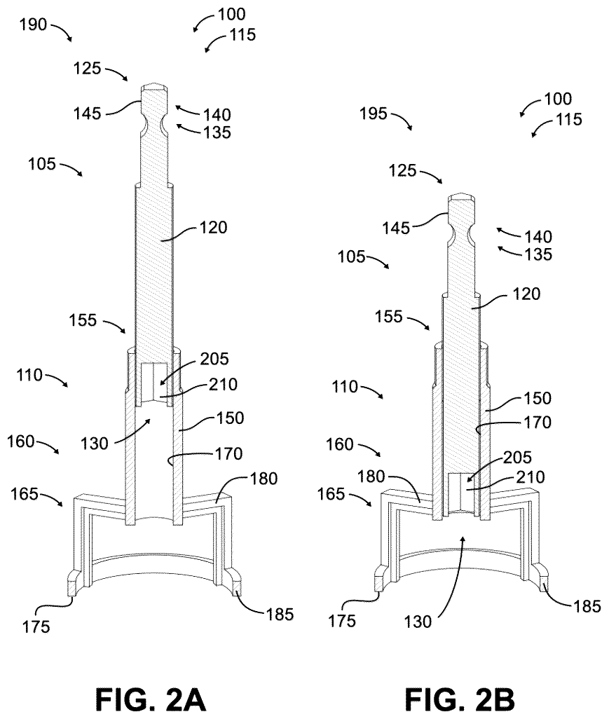

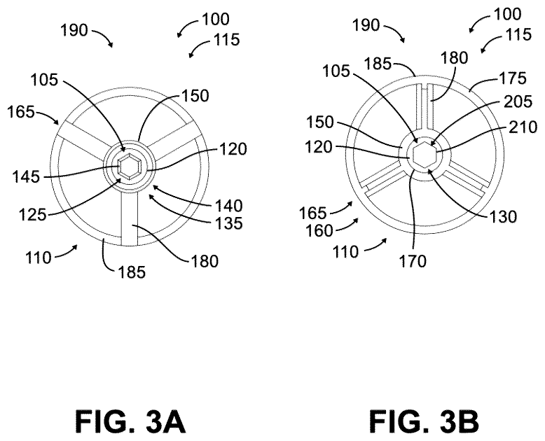

FIGS. 2A and 2B show sectional views of the rotary tool guide 100 of the version of FIGS. 1A and 1B in the retracted position 190 and the advanced position 195, respectively. As can be seen in FIGS. 2A and 2B, the rotary shaft second end 130 is equipped with an object engaging mechanism 205 adapted to allow for engagement with an object that is to be rotated to that the object rotates with the rotary shaft 120. The object engaging mechanism 205 is sized, shaped, and adapted to engage with the object that is to be rotated in a manner that rotation of the rotary shaft 130 will cause rotation of the object. In the particular version shown, the object connecting mechanism 205 comprises a cavity 210 having a hexagonal shape, or the like, and is sized and shaped to receive a hexagonal portion of the object to be rotated, such as a hex shank on a bit. Additional features, such as a chuck, magnet, clamp, ball detent, and/or the like, can optionally be provided to more securely connect the object to be rotated to the rotary shaft 120. FIGS. 3A and 3B show top and bottom views of the rotary tool guide 100 of the version of FIGS. 1A and 1B, respectively, relative to a vertically downward drilling direction.

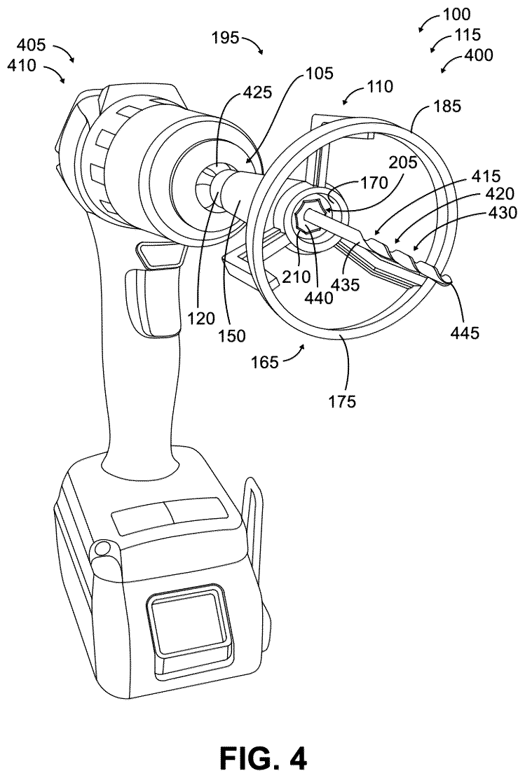

FIG. 4 shows the rotary tool guide 100 of the version of FIGS. 1A and 1B in use as part of a drilling system 400. In the version, the drilling system 400 comprises the rotary tool guide 100 and a rotary tool 405, such as a handheld drill 410, and/or an object to be rotated 415, such as a bit 420. The drill 410 in this version of a drilling system 400 can be any convention handheld drill or the like. In the particular version shown, the drill 410 includes a chuck 425 that can be used to clamp onto the releasable connector 140 of the rotation transmission member 105 of the rotary tool guide 100. Once connected, the actuation of the drill 410 will cause rotation of the rotation transmission member 105 which will in turn cause rotation of the object to be rotated 415 that is engaged by the object engagement mechanism 205 of the rotation transmission member 105. In the particular version of FIG. 4, the object to be rotated 415 is bit 420 in the form of a drill bit 430 designed to create a hole in an object to be drilled. The drill bit 430 comprises a shaft 435 that extends from a rotational engagement head 440 to a drill bit tip 445. The shaft 435 can be provided with helically shaped groove or cutting edges, or the like, as conventionally known. The object to be rotated 415, such as the bit 420, is inserted into the cavity 210 of the object engaging mechanism 205 or otherwise connected to the object engaging mechanism 205. In the version shown, the rotational engagement head 440 of the bit 420 is adapted to be received within the cavity 210 of the object engagement mechanism 205. In one particular version, the rotational engagement head 440 comprises a hex shank similar to or substantially the same as the hex shank 145 of the rotation transmission member 105. Different sizes and/or types of bits 420 can be easily exchanged using the object engaging mechanism 205 of the rotary tool guide 100 and the rotational engagement head 440 of the respective bits 420. For example, in one version, the drilling system 400 comprises a plurality of different types and/or size bits 420, and each of the bits 420 includes a similar bit connection head 430. This allows the rotary drill guide 100 to be universally used with different sizes and/or types of bits 420.

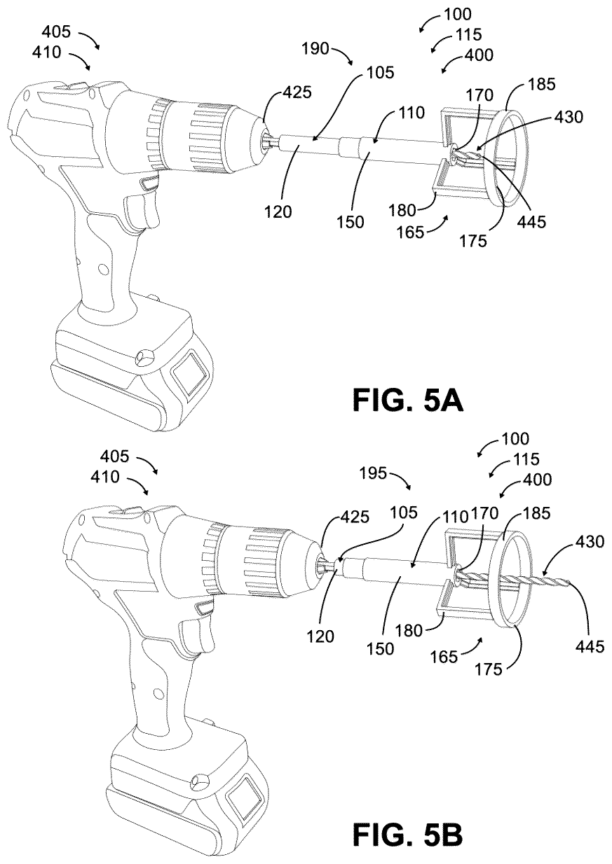

Operation of the rotary tool guide 100 as part of a drilling system 400 is shown in FIGS. 5A and 5B. FIG. 5A shows the drilling system 400 of FIG. 4 with the rotary tool guide 100 in a retracted position 190. As can be seen in FIG. 5A, in the retracted position 190, the drill bit tip 445 is positioned at or rearwardly of the contacting surface 175 of the tool guiding member 110. As the rotary tool guide 100 is moved from the retracted position 190 of FIG. 5A to the advanced position 195 of FIG. 5B, the rotary shaft 120 of the rotation transmission member 105 slides longitudinally within the tool guide shaft lumen 170 and the drill bit 430 is also advanced so that the tip extends forwardly of the contacting surface 175 of the tool guiding member 110.

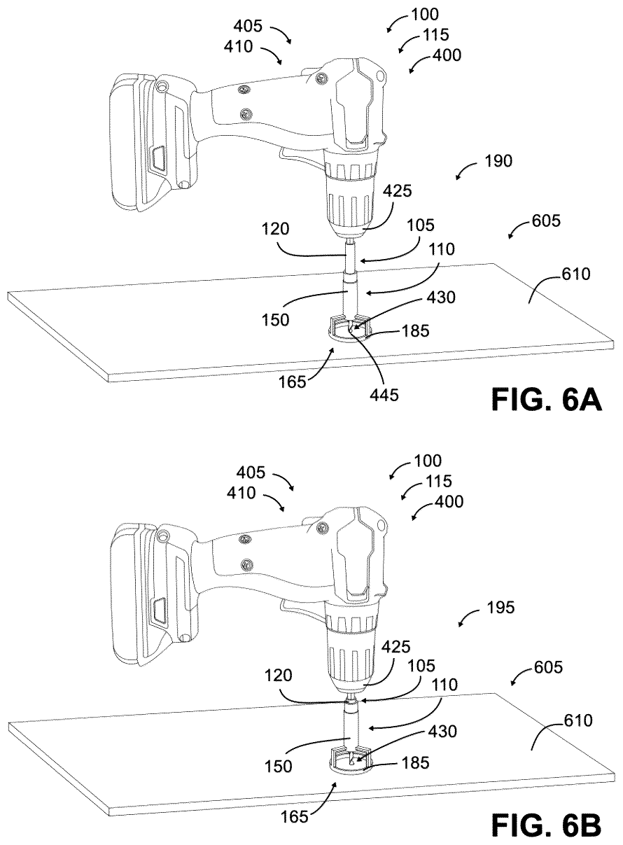

The drilling system 400 is shown in use drilling a hole in FIGS. 6A and 6B. FIG. 6A shows the rotary tool guide 100 in its retracted position 190 before a drilling process begins. The drilling system 400 is positioned so that the drill bit tip is positioned in proximity to an object 605, such as a workpiece, at a location in which a hole is to be drilled. The surface contacting member 165 of the tool guiding member 110 contacts the surface of the object 605 around the location of the hole to be drilled. In the version shown, the contacting surface 175 is a planar surface on the underside of the platform 185, and the plane defined by the contact surface 175 of the platform 185 is oriented at a desired angle relative to the longitudinal axis of the rotary shaft 120 and/or the longitudinal axis of the drill bit 430. As the rotary shaft 120 and the drill bit 430 are advanced to the advanced position 195 of FIG. 6B, a hole is drilled in the object 605 by the rotating drill bit 430. The surface contacting member 165 is angularly fixed with respect to the tool guide shaft lumen 170. In addition, the angle of the rotary shaft 120 is maintained by the tool guide shaft lumen 170 so that the longitudinal axis of the rotary shaft 120 is maintained parallel to the longitudinal axis of the tool guide shaft lumen 170. Accordingly, the angle of the rotary shaft 120 and thus the angle of advancement of the drill bit 430 is maintained at the desired angle with respect to the surface contacting member 165. By positioning the surface contacting member 165 on the top surface 610 of the object 605 being drilled, such as a top surface of a workpiece, the angle of the hole being drilled by the drill bit 430 is maintained at the desired angle. The surface contacting member 165 helps to prevent tilt or wobble of the drill 410 that can change the angle of the drill bit 430. Therefore, by maintaining contact or full contact of the surface contacting member 165 with the top surface 610 of the object 605, it can be assured that a hole is being drilled at the desired angle. By top surface, it is meant the surface in proximity to the location that is to be drilled as shown in the orientation of FIGS. 6A and 6B, and the surface referred to can be in any directional orientation.

While FIGS. 6A and 6B show a drilling process involving the creating of a hole using a drill bit 430, a similar process can be used for otherwise using the rotary tool 405. For example, the bit 420 that is engaged by the rotation transmission member 105 can be a driver bit. The driver bit has a tip configured to engage the head of a fastener or the like. For example, the driver bit tip can have a flat head or Phillips head screw engaging design so that the driver tip can drive a flat head or Phillips head screw. The fastener will have a longitudinal axis that is parallel to the longitudinal axis of the rotary shaft 120 and the tool guide shaft lumen 170. Accordingly, the rotary tool guide 100 can be used to guide the insertion angle of the screw or other fastener or other object being rotated.

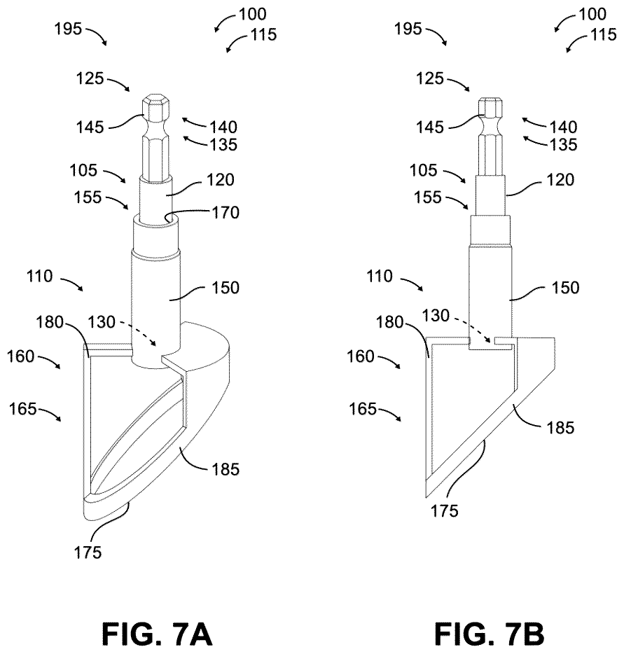

In the particular version of FIGS. 1A and 1B as shown in use in FIGS. 6A and 6B, the plane defined by the contacting surface 175 of the platform 185, or other contacting surface 175 in the absence of a platform 185, is oriented 90 degrees relative to the longitudinal axis of the drill guide shaft lumen 170, the longitudinal axis of the rotary shaft 120 and/or the longitudinal axis of the drill bit 430. In the version shown, the longitudinal axis of the drill guide shaft lumen 170, the longitudinal axis of the rotary shaft 120 and the longitudinal axis of the drill bit 430 are all parallel and/or colinear. Thus, in this version, the hole that is drilled in the object 605 is at about 90 degrees with respect to the top surface 610 of the object 605. Alternatively, and in similar manner, the angle of the hole that is drilled in the object 605 can be changed by having a plane defined by the contact surface 175 of the surface contacting member 165 be angled relative to the axis of the tool guide shaft lumen 170 at an angle other than 90 degrees. For example, FIGS. 7A and 7B show a version of a rotary tool guide 100 in which the tool guiding member 110 is designed to advance the rotation transmission member 105 and/or the drill bit 430 at an angle other than 90 degrees with respect to the top surface 610 of the object 605. In the version shown, the surface contacting member 165 has a contacting surface 175 that defines a plane angled at about 45 degrees with respect to the longitudinal axis of the tool guide shaft lumen 170. As a result, the rotary shaft 120 advances the drill bit 430 at about a 45 degree angle relative to the top surface 610 of the object 605 when the surface contacting member 165 contacts and/or lies flat on the top surface 610.

The size and shape of the contacting surface 175 and/or the platform 185 can be selected so as to be suitable for the use or application of the rotary tool guide 100. For example, the contour of the contacting surface 175 can be designed to correspond to and/or accommodate the top surface 610 of the object to be drilled into. For example, when the top surface 610 is planar, the contacting surface 175 can define a plane that defines the orientation angle and the plane of the contacting surface 175 can rest on the plane of the top surface 610. The rotary shaft 120 and/or the bit 420 will advance at the orientation angle relative to the plane defined by contacting surface 175 and thus the plane of the top surface 610. When the top surface 610 is curved or rounded, the orientation angle will be defined relative to a tangential plane. For example, for a round surface, a 90 degree orientation angle will drill a hole in the rounded surface at a 90 degree angle relative to a plane tangential to the point of drilling or fastener insertion, and a 45 degree orientation angle will drill a hole into the surface at a 45 degree angle relative to the tangential plane. For non-planar top surfaces 610, the contacting surface 175 and/or the platform 185 can be shaped to correspond to the shape of the top surface 610. Alternatively, the three point design can be provided, as discussed below. The diameter or equivalent cross-sectional dimension of the contacting surface 175 and/or platform 185 can be adjusted as desired. For example, the diameter can be increased to increase stability or can be decreased to allow the rotary tool to be used in small or tight spaces or close to internal corners. Optionally, the diameter or equivalent dimension is adjustable.

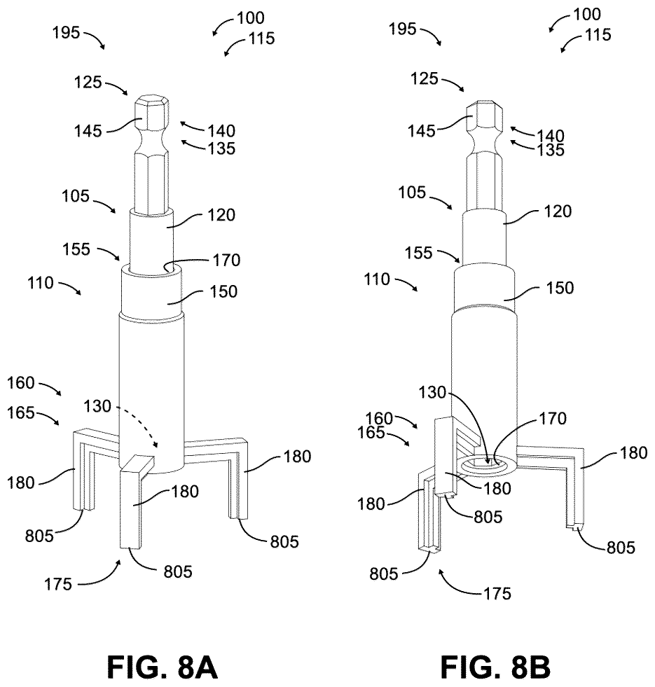

FIGS. 8A and 8B show another version of the rotary tool guide 100 of the invention. The version of FIGS. 8A and 8B is similar to the version of FIGS. 1A and 1B. However, in the version of FIGS. 8A and 8B, the platform 185 is removed and the contacting surface 175 comprises a plurality of separated surfaces 805. In the particular version shown, the separated surfaces 805 are each at the ends of respective forwardly projecting legs 180. In the particular version shown, there are three separated surfaces 805. The three separated surfaces define a plane, and the plane defined by the three separated surfaces 805 can be oriented relative to the tool guide shaft lumen 170 as desired and as discussed above to define the orientation angle. In the particular version of FIGS. 8A and 8B, the plane defined by the three separated surfaces 805 is perpendicular to the tool guide shaft lumen 170 so that the rotation transmission member 105 is advanced at a 90 degree angle relative to the top surface 610 of an object 605. To alter the orientation angle, one or more of the forwardly projecting legs 180 can be shortened or lengthened. The three point contacting surface 175 of the version of FIGS. 8A and 8B is particularly useful when the top surface 610 of an object to be drill is not planar. By contacting a non-planar top surface 610 with the three points, a plane will be defined that is parallel to the tangential plane of the contact surface or that is oriented at an orientation angle relative to the tangential plane. A four point contact can be provided for drilling into pipes, spheres, or the like. Also the three point contacting surface design of FIGS. 8A and 8B allows the rotary tool to be used with just two contacting surfaces contacting the top surface 610, which will leave one axis or direction flexible to be free handed during use. Optionally, a two point design can also be provided and used in the manner discussed above with the three point design where only two points contact the surface.

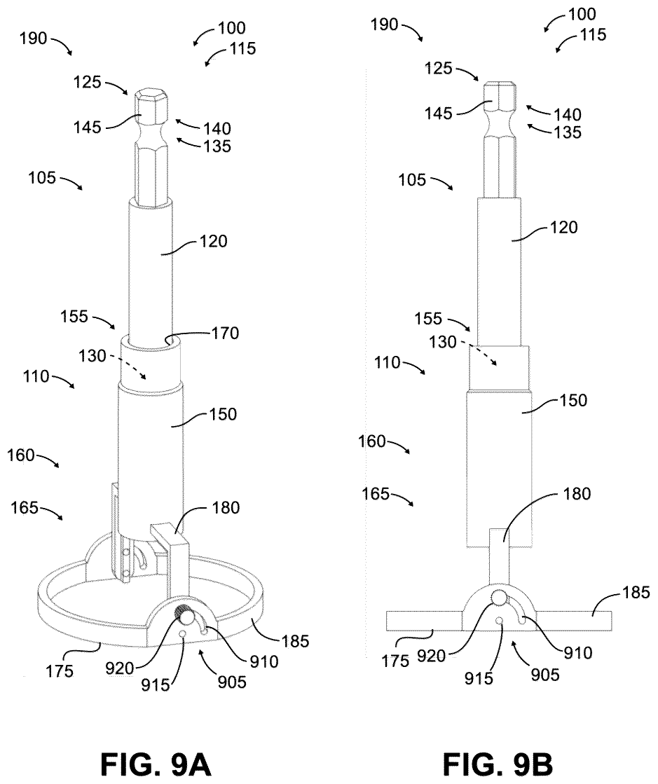

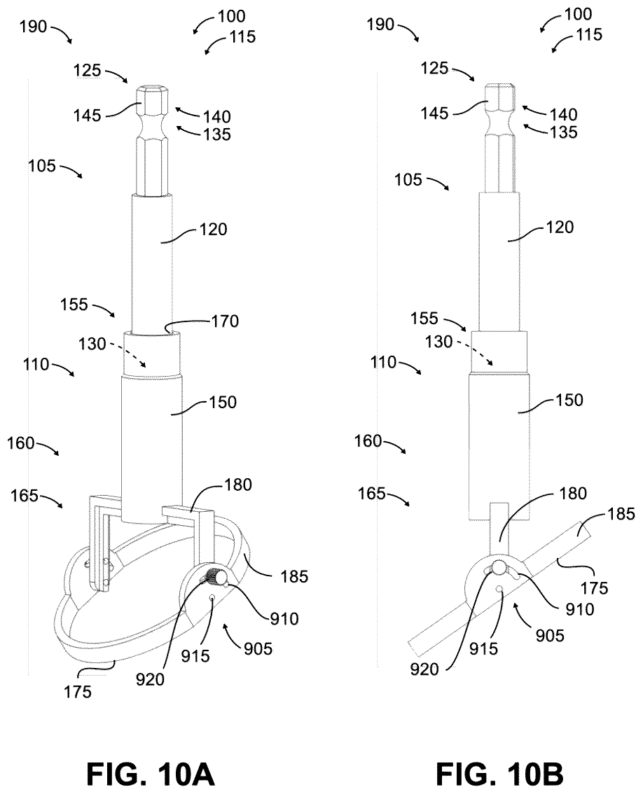

FIGS. 9A and 9B show another version of the rotary tool guide 100 of the invention. The version of FIGS. 9A and 9B is similar to the version of FIGS. 1A and 1B. However, in the version of FIGS. 9A and 9B, the angle of the surface contacting member 165 is adjustable. In the version shown, the angle of the plane defined by the contacting surface 175 of the platform 185 is adjustable. In this version, an angle adjustment mechanism 905 that allows the angular orientation of the planar platform 185 to be adjusted relative to the forwardly projecting legs 175 and thereby adjusted relative to the tool guide shaft lumen 170. In the particular version shown, the angle adjustment mechanism 905 comprises an arcuate slot 910 in a portion of the platform 185. The platform 185 is pivotally connected to a pair of forwardly projecting legs 180 at a hinge 915. A clamping screw 920 passes through the arcuate slot and is threaded into a forwardly projecting leg 180. Advancement of the clamping screw 920 causes a head of the clamping screw 920 to press against the sides of the arcuate slot 910 to prevent pivoting of the platform 185 and to lock the platform 185 in a desired angular orientation. In the orientation of FIGS. 9A and 9B, the platform 185 is locked at about a 90 degree angle relative to the tool guide shaft lumen 170. In this orientation, the rotary tool guide operates in similar manner to the version of FIGS. 1A and 1B. In the orientation of FIGS. 10A and 10B, the platform 185 is locked at about a 35 degree angle relative to the tool guide shaft lumen 170. The angular orientation can be adjustable from an angle of about 90 degrees to an angle of about 0 degrees. The 0 degree angle can be useful when it is desired to advance the rotary shaft 120 and or a bit 420 parallel to a surface that is being contacted by the surface contacting member 165. The side edges and/or surfaces of the platform 185 can also be used to orient the location of a hole to be drilled relative to a corner or feature that the platform 185 can be held against or in proximity to.

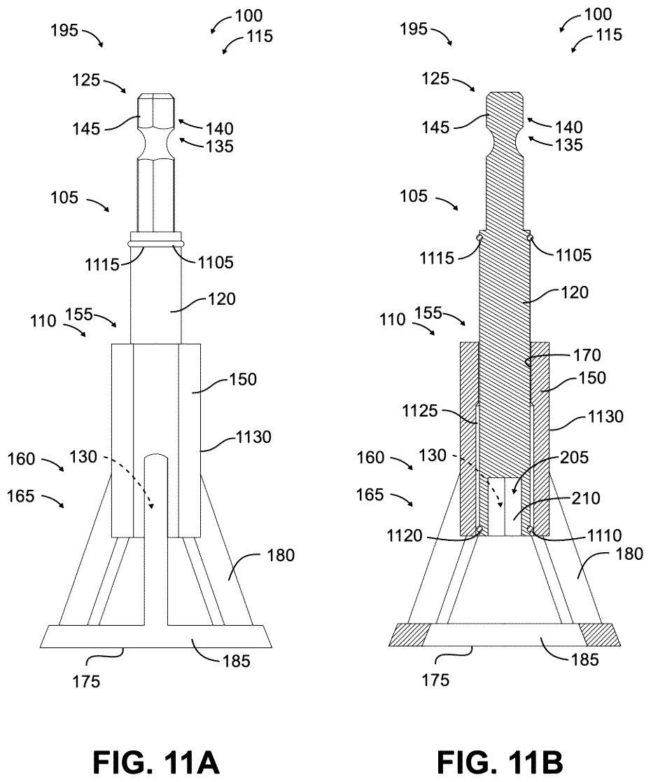

FIGS. 11A and 11B show another version of the rotary tool guide 100 of the invention. The version of FIGS. 11A and 11B is similar to the version of FIGS. 1A and 1B. In the version of FIGS. 11A and 11B, a first retaining ring 1105 and a second retaining ring 1110 are provided to prevent the separation of the rotation transmission member 105 and the tool guide member 110. The first retaining ring 1105 is positioned within a first transverse groove 1115 on the rotary shaft 120 of the rotation transmission member 105. The second retaining ring 1110 is positioned within a second transverse groove 1120 on the rotary shaft 120 of the rotation transmission member 105. The first retaining ring 1105 and the second retaining ring 1110 can be round or any other suitable shape. The first retaining ring 1105 extends outwardly from the outer surface of the rotary shaft a sufficient distance that it cannot fit within the tool guide shaft lumen 170 at the rotary shaft receiving end 155 of the tool guide shaft 150. Accordingly, the first retaining ring 1105 prevents over insertion of the rotary shaft 120 in the tool guide shaft lumen 170. The tool guide shaft lumen 170 has a slightly wider portion 1125 at its forward end than at the rotary shaft receiving end 155 of the tool guide shaft 150. The wide portion 1125 allows the second retaining ring 1110 to slide within the tool guide lumen 170. However, the narrower tool guide shaft lumen 170 at the rotary shaft receiving end 155 of the tool guide shaft 150 prevents the rotary shaft 120 from being pulled out of the tool guide shaft lumen 170 because the second retaining ring 1110 is too wide to pass through the narrower portion of the lumen 170. The version of FIGS. 11A and 11B have additional optional features. For example, in the version of FIGS. 11A and 11B, the exterior surface 1130 of the tool guide shaft 150 is polygonally shaped with flat surfaces to provide surfaces for a user to grip with their non-drill holding hand, if desired. As can also be seen, in the version of FIGS. 11A and 11B, the forwardly projecting legs 180 are angled and straight instead of being bent as in the version of FIGS. 1A and 1B.

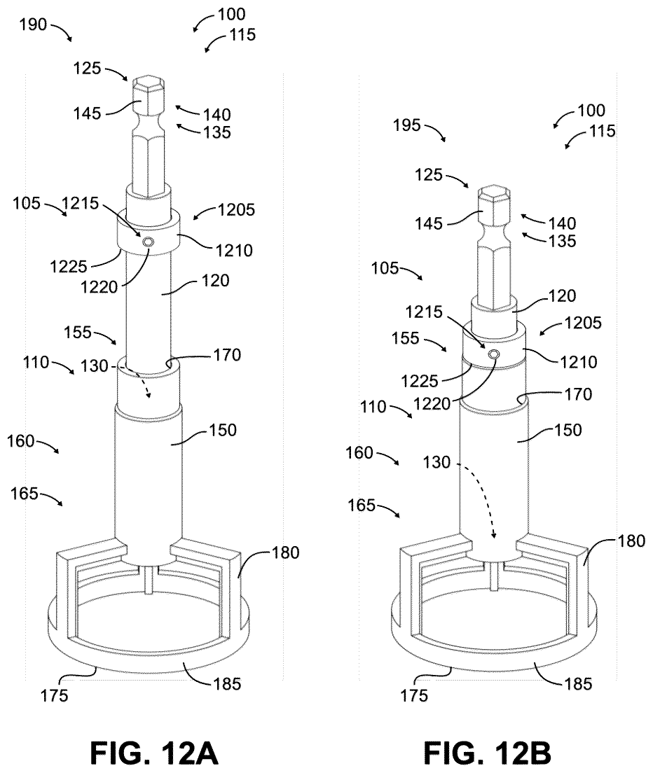

FIGS. 12A and 12B show another version of the rotary tool guide 100 of the invention. The version of FIGS. 12A and 12B is similar to the version of FIGS. 1A and 1B. In the version of FIGS. 12A and 12B, in addition to an insertion angle guide 115, the rotary tool guide 100 of this version is a depth of insertion guide 1200 and includes an insertion depth limiting mechanism 1205. The insertion depth limiting mechanism 1205 in the version shown comprises a collar 1210 that slides longitudinally on the exterior surface of the rotary shaft 120 of the rotation transmission member 105. A position locking mechanism 1215, such as a set screw 1220 or the like, is provided to lock the collar 1210 at a desired position on the exterior surface of the rotary shaft 120. In the version shown, the set screw 1220 extends through a threaded hole in the collar 1210 and when inserted fully the end of the set screw contacts the exterior surface of the rotary shaft 120 to lock the collar 1210 in place. The collar 1210 includes an abutment surface 1225 that contacts the tool guide shaft 150 when the rotary shaft 120 is advanced in the tool guide shaft lumen 170 to a position associated with the maximum desired insertion depth of a bit 420 or other object to be rotated.

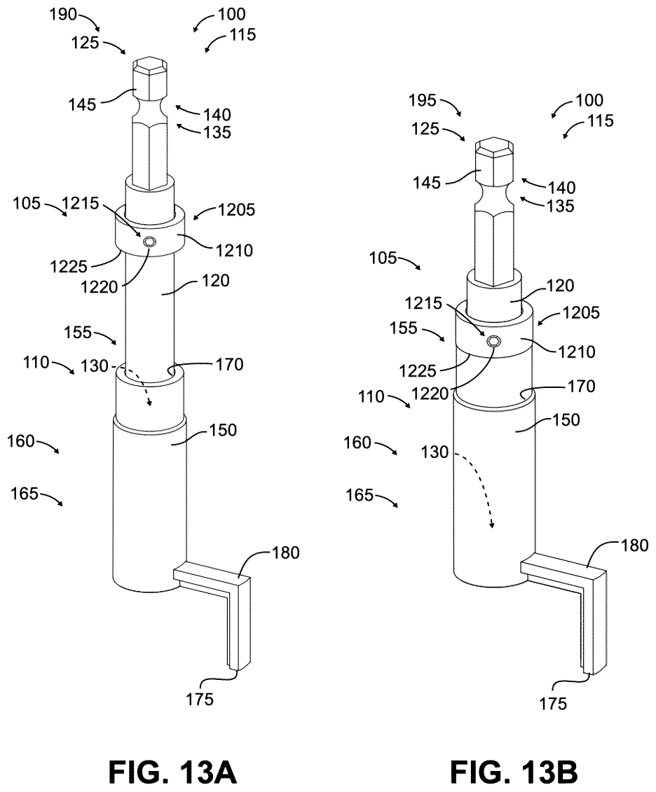

FIGS. 13A and 13B show another version of the rotary tool guide 100 of the invention. The version of FIGS. 13A and 13B is similar to the version of FIGS. 12A and 12B except in the version of FIGS. 13A and 13B there is no insertion angle guide aspect to the rotary tool guide 100. In this version the rotary tool guide 100 guides the insertion depth as in the version of FIGS. 12A and 12B. Since the angle of insertion is not maintained, the surface contacting member 165 can comprise a single forwardly projecting leg 180 and/or a single contacting surface 175.

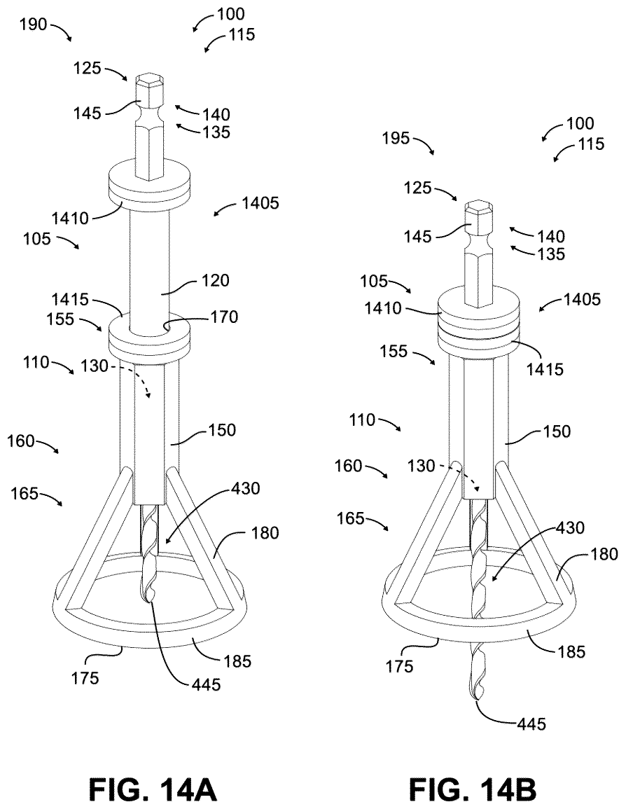

FIGS. 14A and 14B show another version of the rotary tool guide 100 of the invention. The version of FIGS. 14A and 14B is similar to the version of FIGS. 1A and 1B. In the version of FIGS. 14A and 14B, the rotary tool guide 100 includes a biasing mechanism 1405 that serves to bias the rotary tool guide 100 in its retracted position 190. In the version of FIG. 14, the biasing mechanism 1405 operates by magnetic repulsion. A first magnet 1410, such as a permanent magnet is positioned or fixed on the rotary shaft 120 of the rotation transmission member 105. A second magnet 1415 is positioned, abutting, or fixed on the tool guide shaft 150. The first magnet 1410 and the second magnet 1415 are oriented so the poles create a repulsion force. By repelling the first magnet 1410 from the second magnet 1415, the tool guide shaft 150 is biased or urged forwardly of the rotary shaft 120 in the absence of other forces. In this manner, the rotary tool guide 100 is naturally in its retracted position 190, as shown in FIG. 14A. To move the rotary tool guide 100 to is advanced position 195, as shown in FIG. 14B, the tool guiding member 110 contacts a surface of an object 605 and the rotation transmission member 105 is forced forwardly against the force of the magnetic bias. Once the drill process has been completed, the forward force is removed, and the magnetic bias returns the rotary tool guide 100 to its retracted position 190. In this version, the first magnet 1410 can also serve as an over-insertion stop or retaining mechanism and/or can be positionable along the rotary shaft 120 to serve as a depth of insertion limiting mechanism. Alternatively, the magnets can be positioned so that an attraction between the magnets biases the rotary tool guide 100 to the retracted position 190, such as by placing one of the magnets on the rotary shaft 120 at a position forward of a magnet on the tool guide shaft 150. In another version, the biasing mechanism 1405 can be provided by a spring arrangement. For example a compression spring positioned between the rotation transmission member 105 and the tool guide shaft 150. The compressed spring then urges the rotation transmission member 105 away from the tool guide member 110 and towards the retracted position 190. In another version, it may be desired to bias the rotary tool guide 100 towards the advanced position 190. In this version, which can be accomplished by reversal of the arrangements discussed above, a force can be applied by a user to move the rotary tool guide 100 to its retracted position 190 prior to a drill process.

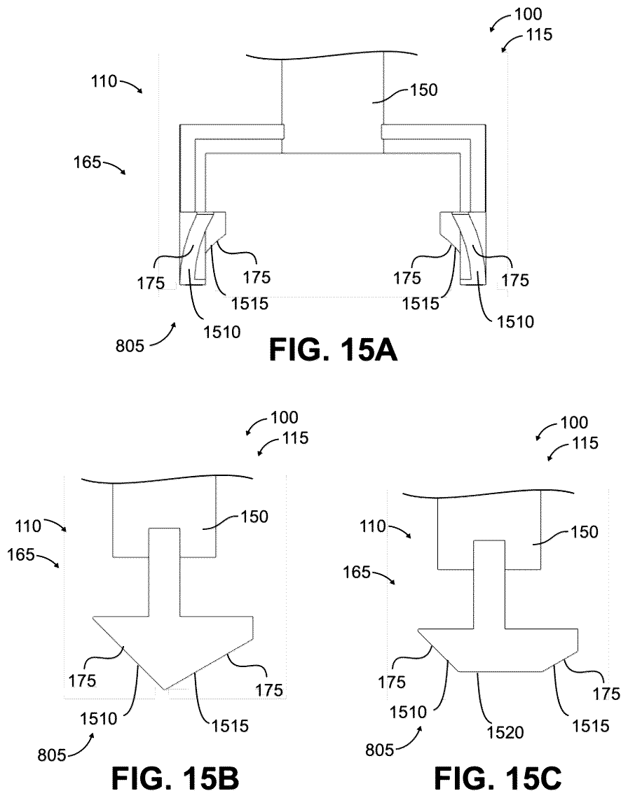

FIGS. 15A and 15B show another version of a portion of the rotary tool guide 100 of the invention. In the version of FIGS. 15A and 15B the surface contacting member 165 is a multi-contacting surface contacting member 1505 and includes multiple contacting surfaces 175 that allows for different orientation angles to be selected without adjusting or replacing the surface contacting member 165. In this version, the surface contacting member 165 include a first contacting surface 1510 oriented at a first angle and a second contacting surface 1515 oriented at a second angle different than the first angle. A user can tilt the rotary tool and the rotary tool guide 100 one way or the other so that a desired contacting surface 175 of the first contacting surface 1510 and/or the second contacting surface 1515 contacts the object to be drilled into. FIG. 15C shows a version with a third contacting surface 1520 at an angle other than the first contacting surface 1510 and the second contacting surface 1515. In the version shown, the third contacting surface 1520 is at a 90 degree angle. The first contacting surface 1510, the second contacting surface 1515, and the third contacting surface 1520 can each be any suitable angle, such as one of about 90 degrees, 60 degrees, 45 degrees, 30 degrees, and 0 degrees.

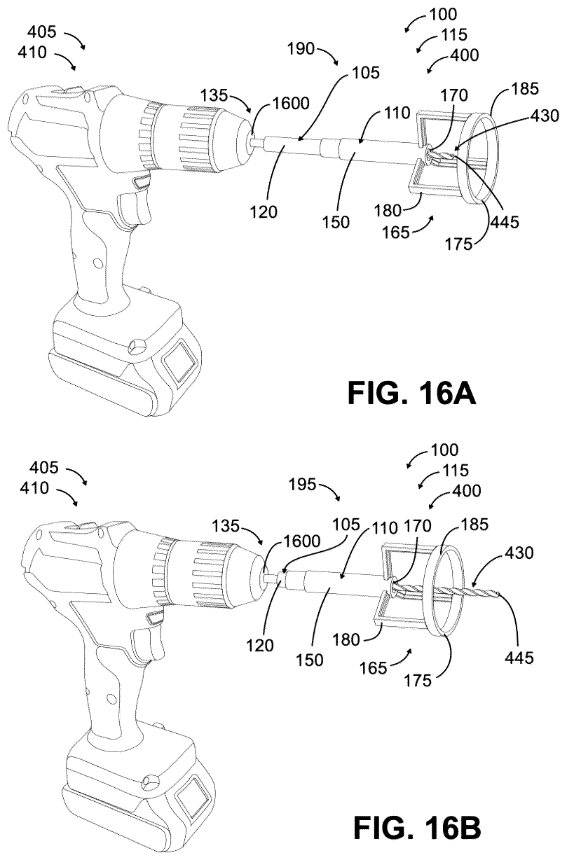

FIGS. 16A and 16B show another version of the rotary tool guide 100 of the invention. In the version of FIGS. 16A and 16B, the rotary tool guide 100 is integrally and/or permanently attached to the rotary tool 405, such as a drill 410. In this version, the mount 135 comprises a permanent connection 1600. Accordingly, in this version, the drilling system comprises a rotary tool 405 comprising and equipped with rotary tool guide 100 and to which a bit 420 can be attached. The rotary tool guide 100 in this version can be in accordance with any of the herein described versions.

Various alterations and other versions can also be provided. For example, one or more of the shafts of the rotary tool guide 100 can telescope to allow for longer drilling or the like. Also, a countersinking mechanism can be included. The rotary tool guide 100 can alternatively be used for a non-rotational tool whenever an orientation angle and/or a depth of insertion is in need of being guided.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person of ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and to include zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A rotary tool guide comprising:
a rotation transmission member comprising a rotary shaft extending from a mount at a rotary shaft first end to a rotary shaft second end, wherein the mount is adapted to connect the rotation transmission member to a rotary tool, and wherein the rotary shaft second end is equipped with an object engaging mechanism adapted to engage an object that is to be rotated; and
a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface adapted to contact a surface of a workpiece,
wherein the contacting surface of the surface contacting member defines an orientation angle relative to a longitudinal axis of the tool guide shaft lumen so that when the rotary shaft is moved within the tool guide shaft lumen from a retracted position to an advanced position, the rotary shaft is maintained at the orientation angle relative to the surface of the workpiece that is contacted by the surface contacting member.

2. A rotary tool guide according to claim 1 wherein the orientation angle is about 90 degrees.

3. A rotary tool guide according to claim 1 wherein the orientation angle is about 45 degrees.

4. A rotary tool guide according to claim 1 wherein the orientation angle is adjustable from about 90 degrees to about 0 degrees.

5. A rotary tool guide according to claim 1 wherein the mount is releasably connectable to the rotary tool.

6. A rotary tool guide according to claim 1 wherein the mount is permanently attached to the rotary tool.

7. A rotary tool guide according to claim 1 wherein the object to be rotated is a bit and wherein the object engaging mechanism is adapted to engage a head of the bit.

8. A rotary tool guide according to claim 1 wherein the contacting surface is a planar continuous surface.

9. A rotary tool guide according to claim 1 wherein the contacting surface comprises a plurality of separated surfaces.

10. A rotary tool guide according to claim 1 wherein the rotary tool guide further comprises a depth of insertion limiting mechanism.

11. A rotary tool guide according to claim 1 wherein the rotary tool guide further comprises a biasing mechanism adapted to bias the rotary tool guide towards the retracted position.

12. A drilling system comprising:
a rotary tool;
a rotary tool guide, the rotary tool guide comprising:
a rotation transmission member comprising a rotary shaft extending from a mount at a rotary shaft first end to a rotary shaft second end, wherein the mount connects the rotation transmission member to the rotary tool, and wherein the rotary shaft second end is equipped with a bit engaging mechanism adapted to engage a bit that is to be rotated; and
a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface adapted to contact a surface of a workpiece; and
one or more bits adapted to be engaged by the bit engagement mechanism in a manner where rotation of the rotary shaft causes rotation of the bit,
wherein the contacting surface of the surface contacting member defines an orientation angle relative to a longitudinal axis of the tool guide shaft lumen so that when the rotary shaft is moved within the tool guide shaft lumen from a retracted position to an advanced position, the rotary shaft and a bit engaged by the bit engaging mechanism are maintained at the orientation angle relative to the surface of the workpiece that is contacted by the surface contacting member.

13. A drilling system according to claim 12 wherein the one or more bits comprises a plurality of different bits, each bit comprising a similar bit head that is engageable with the bit engaging mechanism, wherein a selected one of the plurality of different bits can be engaged by the bit engaging mechanism.

14. A drilling system according to claim 12 wherein the rotary tool is a handheld drill.

15. A drilling system according to claim 12 wherein the orientation angle is one or more of about 90 degrees, about 45 degrees, about 30 degrees, and about 60 degrees.

16. A method of using a rotary tool, the method comprising:
providing a rotary tool connected to a rotary tool guide, wherein the rotary tool guide comprises:
a rotation transmission member comprising a rotary shaft extending from a rotary shaft first end to a rotary shaft second end, wherein the rotary shaft second end is equipped with an object engaging mechanism; and
a tool guiding member comprising a tool guide shaft and a surface contacting member, wherein the tool guide shaft comprises a tool guide shaft lumen adapted to receive the rotary shaft therein, wherein the rotary shaft is slidable and rotatable within the tool guide shaft lumen, and wherein the surface contacting member comprises a contacting surface;
engaging an object to be rotated with the object engaging mechanism;
contacting a surface of a workpiece with the contacting surface of the surface contacting member;
rotating the rotary tool and thereby rotating the rotary shaft and the object to be rotated; and
advancing the rotary shaft within the tool guide shaft lumen and thereby advancing the object to be rotated,
wherein the contacting surface of the surface contacting member defines an orientation angle relative to a longitudinal axis of the tool guide shaft lumen so that when the rotary shaft and the object to be rotated are advanced, the rotary shaft and the object to be rotated are maintained at the orientation angle relative to the surface of the workpiece that is contacted by the surface contacting member.

17. A method according to claim 16 wherein the object to be rotated is a drill bit.

18. A method according to claim 16 wherein the object to be rotated is a driver bit.

19. A method according to claim 16 wherein the orientation angle is one or more of about 90 degrees, about 45 degrees, about 30 degrees, and about 60 degrees.

20. A method according to claim 16 wherein the step of advancing the rotary shaft within the tool guide shaft lumen comprises applying a sufficiently strong translation force to overcome a bias that biases the rotary shaft away from the tool guide shaft.
